(19) United States
(12) Patent Application Publication
(10) Pub. No.: US 2016/0092154 A1
(43) Pub. Date: Mar. 31, 2016

(54) CONTENT MIRRORING

(71) Applicant: International Business Machines Corporation, Armonk, NY (US)

(72) Inventors: Ronan R. F. Bourlier, Teyran (FR); Guillaume Hoareau, Montpellier (FR)

(21) Appl. No.: 14/864,003

(22) Filed: Sep. 24, 2015

(30) Foreign Application Priority Data
Sep. 30, 2014 (GB) 1417264.7

(51) Int. Cl. G06F 3/14; G06F 21/60; G09G 5/12

(52) U.S. Cl. CPC G06F 3/1454; G06F 3/1438; G09G 5/12; G06F 21/60; G09G 2360/04

(57) ABSTRACT

A method of mirroring the content of a first display device on a second display device, the method includes displaying content on the first display device, displaying the content on the second display device, detecting the input of text on a user interface device associated with the first display device, and interrupting the display of the content on the second display device. The interrupting of the display of the content on the second display device can comprise freezing the display of the content on the second display device.

### FIELD OF THE INVENTION

This invention relates to a method of, and system for, mirroring the content of a first display device on a second display device.

### BACKGROUND

Hardware and software solutions exist which allow the content of one display device to be mirrored onto a second display device. For example, a user with a laptop computer may be making a presentation to a larger audience and the content of the laptop screen can be mirrored to an external display device such a flat screen television or overhead projector. When a presenter is displaying a source of information from a main device (such as a PC, mobile phone or tablet computer for example) using a projector or a secondary display, the information displayed on the secondary screen is equal to the information coming from the source.

In the case of mobile device such as a smartphone without a physical keyboard, a keyboard typing helper, if it is being used, will display on both the primary and secondary screens at the same time. Each typed character is temporary visually displayed on both screens and a hacker can simply memorize what they saw displayed on the mirrored screen. The hacker can therefore very easily steal information, such as a password, that is being entered by a user on their primary device, since the content is being mirrored on the second display device. While it is very useful to have a keyboard typing helper on a mobile/tablet interface, this is also a big confidentiality breach regarding what is displayed on the secondary screen. Everyone can see in the clear every typed password just by reading the keyboard typing helper on the secondary screen.

### BRIEF SUMMARY OF THE INVENTION

According to a first aspect of the present invention, there is provided a method of mirroring the content of a first display device on a second display device, the method comprising the steps of displaying content on the first display device, displaying the content on the second display device, detecting the input of text on a user interface device associated with the first display device, and interrupting the display of the content on the second display device.

According to a second aspect of the present invention, there is provided a system for mirroring the content of a first display device on a second display device, the system comprising a first display device arranged to display content thereon, a second display device arranged to display the content thereon, and a processor arranged to detect the input of text on a user interface device associated with the first display device, and interrupt the display of the content on the second display device.

According to a third aspect of the present invention, there is provided a computer program product on a computer readable medium for mirroring the content of a first display device on a second display device, the product comprising instructions for displaying content on the first display device, displaying the content on the second display device, detecting the input of text on a user interface device associated with the first display device, and interrupting the display of the content on the second display device.

Owing to the invention, it is possible to provide a secure screen cloning process between devices that supports mirroring of a main screen to a secondary display. The solution will guarantee the confidentiality of typed information while using virtual keyboard and its visual helper (to avoid mistyping). The secure screen cloning process will be able to mirror a primary screen to another without displaying a password or private credentials in clear in the secondary screen. The method enables and facilitates the use of a mirroring/cloning feature avoiding the confidentiality issue associated with a keyboard typing helper being used on the source terminal.

The secure screen cloning process preferably clones displayed information from a main terminal to a secondary terminal and generates an artificial latency while keyboard typing helper is in use, skipping some frame to prevent characters being read from the secondary screen. This provides a level of security that cannot be obtained by just cloning displayed information to a secondary screen “as-is”.

Almost any mobile device is capable of cloning its screen onto a secondary display. Additionally, most such devices use by default the keyboard typing helper. The system can be utilized to enhance the user experience of sharing what makes sense in justifying the screen cloning, but keeping private some information such as the user's password, codes, and credentials.

Since it is too easy to capture the visual information displayed in real time character by character, the system will preferably skip some frames or generate some latency in order to make it impossible for a viewer of the second screen to understand and catch the secret information highlighted by the keyboard typing helper. Visually from the secondary screen there can be either temporary generation of latency with all characters appearing suddenly and no exploitation possible for a hacker of the keyboard typing helper or frame skipping where each time the keyboard typing helper is used, the secondary screen is not refreshed and no exploitation possible for a hacker of the keyboard typing helper.

Utilizing the solution has a number of advantages as opposed to just cloning a main screen to a secondary display. The most important for the presenter is to show and share to the audience some information while private information stays secret, and the presenter can still use the keyboard typing helper for its normal usage on the user's primary device, such as a smartphone.

Advantageously, the detecting of the input of text on a user interface device associated with a first display device comprises detecting the use of a keypress helper for a password input. The user's device can be configured to detect that the keypress helper is being used as the user is typing in text on their primary device. This can be the trigger to the determination that some sort of display interruption is required. The keypress helper will still work as normal on the user's main device, but the interruption of the mirroring/cloning of the primary display content to the secondary display device ensures that the user's inputs are no longer visible on the secondary display device.

As described above, the interrupting of the display of the content on the second display device can comprise freezing the display of the content on the second display device or reducing the frame rate of the display of the content on the second display device. The interruption of the mirroring has to be effective and the simplest solution is to pause the cloning of the display content while the user is entering their text. Depending upon the software/hardware implementation of the mirroring, this may not be practical, in which case the frame rate can be reduced so that the relevant information is not shown on the secondary display device or is shown for such a short period of time that it cannot be accurately captured by a malicious viewer.

Preferably, the methodology further comprises detecting the termination of the input of text on a user interface device associated with the first display device and resuming the display of the content on the second display device. The interruption in the content mirroring from the main display device to the secondary display device will end once it is determined that the user has stopped entering text on the keyboard associated with the main display device. This could be triggered by the detection that the user has not entered any text for a certain period of time, for example, or could be triggered by the keyboard helper no longer operating, which indicates that the user has finished inputting their password.

### BRIEF DESCRIPTION OF THE DRAWINGS

Preferred embodiments of the present invention will now be described, by way of example only, with reference to the following drawings, in which:—

FIG. 1 is a schematic diagram of a main display being mirrored on a secondary display,

FIG. 2 is a schematic diagram of a mobile phone,

FIG. 3 is a schematic diagram of a different main display being mirrored on the secondary display,

FIG. 4 is a flowchart of events and actions in a mirroring system,

FIG. 5 is a timeline diagram of events in a mirroring process, and

FIG. 6 is a flowchart of a method of mirroring the content of a display device.

### DETAILED DESCRIPTION OF THE DRAWINGS

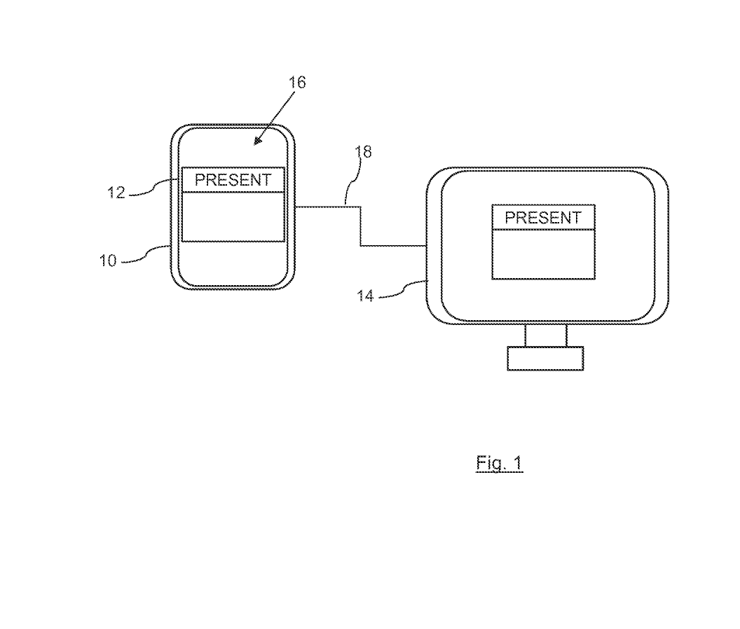

FIG. 1 illustrates the concept of display mirroring. A mobile phone 10 has a display device 12 (a touchscreen) and a flat screen display device 14 is cloning the content 16 of the first display device 12. A wired connection 18 connects the two devices 10 and 14 together. The wired connection 18 could be a simple VGA cable that is providing the display data from the mobile phone 10 to the secondary display device 14. Any changes that occur in the content 16 as it is displayed on the touchscreen 12 are immediately reflected in the content 16 displayed on the secondary display device 14, which is simply receiving a copy of a frame buffer that defines the pixel data for the touchscreen 12.

The configuration shown in FIG. 1 will be used, for example, where a business professional or academic is making a presentation to colleagues and is using their mobile phone 10 as the source of the presentation. The presenter may have a suitable slide based presentation stored on their mobile phone 10, which they will need to show via a larger screen in order that the viewers of the presentation can see the contents of the presentation as the presenter is speaking. The presenter will simply connect their mobile phone 10 to the wired connection, either directly or through a necessary hardware convertor, which will ensure that the screen content 16 is mirrored to the secondary display device 14.

As mentioned above, this configuration suffers from the problem that all of the content 16 that is being displayed on the secondary display device 14 will be automatically mirrored and this can include the mirroring of information that in fact the presenter does not wish to be shown on the secondary display device 14. In order to combat this, the mobile phone 10 is configured in such a way that it will interrupt the mirroring of the display content 16, in specific circumstances. If there is detected the input of text on a user interface device associated with the first display device 12, then this will result in the mirroring being suspended.

In the case of the mobile phone 10 shown in FIG. 1, the keyboard associated with the first display device 12 would be a virtual keyboard shown in the lower half of the touchscreen 12. As is common on many modern smartphones, the majority of the front of the smartphone 10 is taken up with the touchscreen 12 and a keyboard is therefore provided for text entry using a virtual keyboard that appears, when needed, in the lower portion of the touchscreen 12. The user taps on the virtual keys to enter text into the current application being used. The mirroring of the display content 16 will mean that this virtual keyboard is shown on the secondary display device 14.

Since mobile phone design is pushed in two competing directions (small size for ease of mobility and large size for ease of use of the display) it is common that mistakes are made during the typing of characters on a virtual keyboard since the touchscreen 12 is often smaller than desirable. This can often be autocorrected by the mobile phone 10 which will correct misspelt words in text through knowledge of which characters are close together on the standard QWERTY keyboard. For example a user how types “tge” as a word on a small virtual keyboard will have that autocorrected to “the” since the “g” and “h” characters are adjacent on the keyboard.

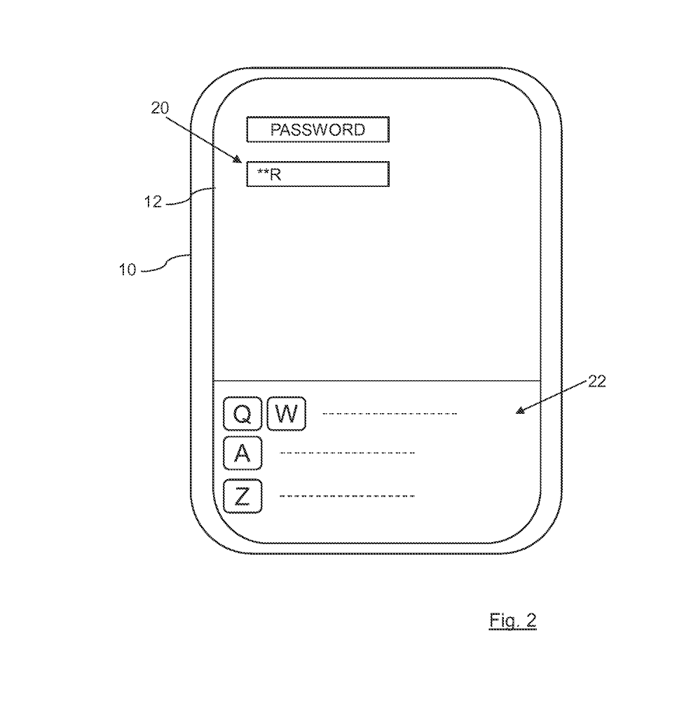

However, if a user is typing a password, this cannot be autocorrected, since the password could be anything and the mobile phone 10 has no way of knowing if the user has made a mistake. Since passwords are usually hidden as they are typed this is a significant problem on small virtual keyboards, so a so-called keypress helper is used, which shows the last character typed in order that the user is able to visually confirm that they have correctly entered the characters in turn. This is shown in FIG. 2, where a password 20 is being entered via a virtual keyboard 22 and the last character entered is shown, while all other previous characters are subsequently hidden with an asterisk.

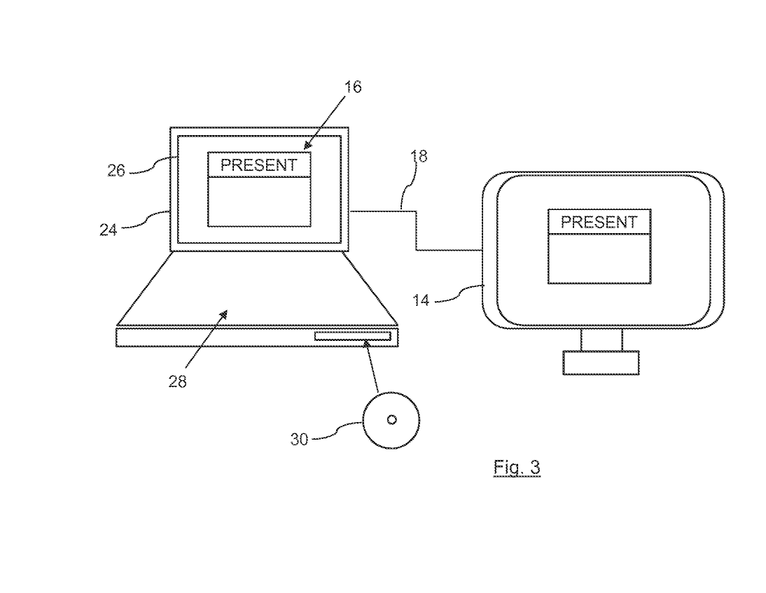

FIG. 3 illustrates a similar situation as to that shown in FIG. 1, where a user is using a laptop computer 24 which is the source for image content 16 that is being mirrored onto the secondary display device 14. The display device 26 of the laptop 24 is the primary display device 26 which shows the user their presentation that is being mirrored onto the secondary display device 14, which is the external flat screen display 14. As before, a VGA cable 18 is connecting the laptop 26 to the flat screen display device 14 and the screen content 16 is automatically copied from the primary display device 26 to the secondary display device 26.

If the user types any text on the laptop's keyboard 28 this will appear on the laptop screen 26, and this text is also instantly mirrored onto the second display 26. For example, when a user turns on their laptop 24, they may need to log in to a network in order to access remote files that they need for their presentation. As the user enters text via the keyboard 28 this will be also shown on the secondary display device 14 in addition to their own laptop screen 26, which means that anybody present for the purpose of seeing and hearing the presentation will also get to see on the secondary display 14 private text. For example, details such as the user's log in name will not necessarily be considered a password as such and will not be hidden using asterisks (as would a password), even though the user may consider that this is confidential information that they do not wish others to know. Should the laptop 24 be using a keypress helper, then as before with the mobile phone 10 example discussed above, the user's keypresses will be shown on the secondary display device 14 as they are entered, before being hidden with an asterisk. The display mirroring creates a security/confidentiality issue for the user who is using their personal device as the source of the display content 16.

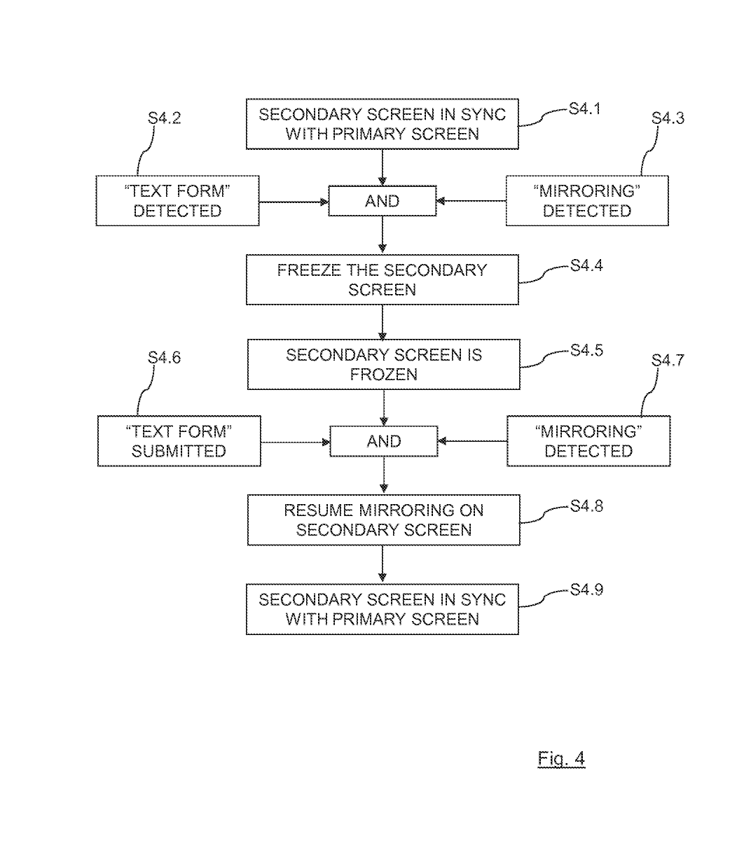

The mirroring methodology implements a way of preventing certain private information being displayed on the secondary display device 14. This is illustrated with the flowchart of FIG. 4. The secondary screen is in synchronization with the primary screen (step S4.1) and when a text form is detected (S4.2) and mirroring is detected (S4.3), then the secondary screen is frozen (S4.4). While the secondary screen is frozen (S4.5) then if the text form is submitted (S4.6) and mirroring is detected (S4.7), then the mirroring is resumed on the secondary screen (S4.8). The mirroring returns to its original state of the secondary screen being in synchronization with the primary screen (S4.9).

The improvement in the mirroring/cloning can be delivered using software code embedded in an application or at operating system level, either of which are possible. In the system shown in FIG. 3, a computer program product stored on a computer readable medium 30 (a CD-ROM) is used to control the processor of the laptop 24. The computer program product comprises instructions for controlling the processor. Using host application privileges, the software code that embodies the protection feature can claim access to information stored locally on the main device, and can trigger read and write operations on the mobile device. FIG. 2 explains the logical process of the software code as it can be implemented as a confidential information protection measure in a display mirroring environment.

The prevention aspect of the mirroring process runs as a silent feature triggered while using a communication application. As normal, the user accesses their standard application and displays on both screens the same information, thereby mirroring the contents of their main display device on a secondary display device. The user sees information on their mobile device screen, and audience sees what the user is delivering on the secondary screen. The same information is displayed on both screens. If the presenter is typing a password, then this event is detected because this will use standard function class calls of two different functionalities, keyboard typing and typed password masking replacing characters by an asterisk (for example).

The innovative solution traps the call(s) and silently freezes the mirroring when the user is typing their password. The keyboard typing helper is displayed on the main device screen, but not on the secondary display because (in one embodiment) the secondary display is frozen on the last valid frame before the user began their password typing. After submitting their password, the software captures the successful password validation and resumes the mirroring of information on both screens. From the audience point of view, there is never any possibility that they can see the password as it is being entered, as the contents of the secondary display are frozen while the user is entering their password on the main device.

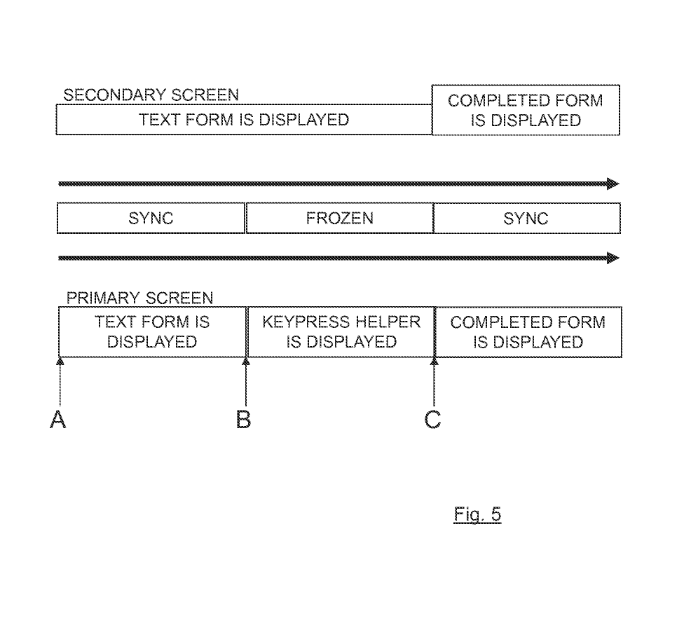

FIG. 5 illustrates a timeline for the primary and secondary screens, when the improved mirroring methodology is in use. The main user device (such as the user's smartphone) associated with the main display device is controlled in order to interrupt the mirroring if there is any text input on a user interface device that is associated with the main display device. At time A, the normal display synchronizing is taking place, with the display contents of the main display device being mirrored to the secondary display device. A text form that requires a login and a password is prompted on the main display device and this is also shown on the secondary display device.

At time B, the user begins to enter their password and the keypress helper is displayed to the user on the primary display device to help the user fill in the form. The display of the secondary display device is frozen at this time. The user enters their password using the keypress helper and this is all displayed on their primary display device as normal, with the last character entered being displayed to the user. However, the output of the secondary display device has not changed and still continues to display the text form requesting a login and password, without any of the entered data being shown. This prevents the viewer of the secondary display device from seeing the confidential data entered by the user.

Once the user has completed entering their password, then at time C, the user will select enter or press return in order to complete the password process. At this point, the mirroring of the two display devices is restarted and the completed text form is shown on the secondary display device just as it is on the main display device. The viewer of the secondary device is not aware that data was visible on the main display device as they simply see a switch from an empty text form to a completed text form, with the asterisks protecting the characters of the password that have been entered by the user on the keyboard associated with that main display device.

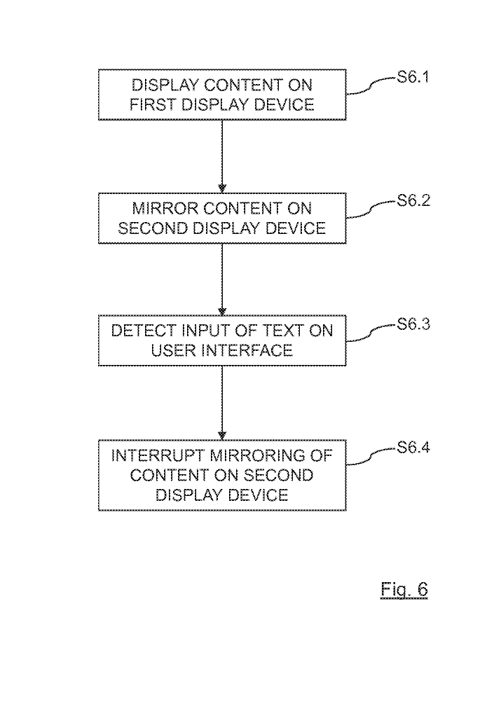

FIG. 6 summarizes the method of mirroring the content of a first display device on a second display device. The method comprises the steps of, firstly step S6.1, which comprises displaying content on the first display device, and secondly step S6.2, which comprises displaying the content on the second display device. The specific method used for mirroring the content from one display device to the other display device is not material to the operation of the improved mirroring method. A hardware or software solution to the mirroring could be used without any impact on the confidentiality protection provided by the improved method. A direct hardware cable could be used or a software network type solution could be used.

The next step in the method comprises step S6.3, which comprises detecting the input of text on a user interface device associated with the first display device. The detection of the text input could take a number of forms. If the method is triggered from the use of the keypress helper, then specific calls to that software element will be monitored and captured as the trigger for detecting the input of text. Other methods could include detection that the user has moved the cursor to a text entry box, presumably in preparation for the entry of text into that box. The actual entry of text itself could be the trigger for detection.

The final step of the method is step S6.4, which comprises interrupting the display of the content on the second display device. As detailed above, once there is detection that the user is entering text on their main device, then the interruption in the display mirroring will kick in. This interruption in its simplest form comprises the freezing of the content on the secondary display to prevent the audience for the secondary display from seeing the user information entered at the keyboard by the user. Other methods of interruption are possible, such as a reduction in the frame rate of the mirroring of the display content. This will keep the secondary screen refreshed, but will not allow a viewer of the secondary screen the chance to read the characters entered by the user.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method of mirroring the content of a first display device on a second display device, the method comprising:
displaying content on the first display device,
displaying the content on the second display device,
detecting the input of text on a user interface device associated with the first display device, and
interrupting the display of the content on the second display device.

2. A method according to claim 1, wherein the step of detecting the input of text on a user interface device associated with the first display device comprises detecting the use of a keypress helper for a password input.

3. A method according to claim 1, wherein the step of interrupting the display of the content on the second display device comprises freezing the display of the content on the second display device.

4. A method according to claim 1, wherein the step of interrupting the display of the content on the second display device comprises reducing the frame rate of the display of the content on the second display device.

5. A method according to claim 1, and further comprising detecting the termination of an input of text on a user interface device associated with the first display device and resuming the display of the content on the second display device.

6. A system for mirroring content of a first display device on a second display device, the system comprising:
a first display device arranged to display content thereon,
a second display device arranged to display the content thereon, and
a processor arranged to detect the input of text on a user interface device associated with the first display device, and interrupt the display of the content on the second display device.

7. A system according to claim 6, wherein the processor is arranged, when detecting the input of text on a user interface device associated with the first display device, to detect the use of a keypress helper for a password input.

8. A system according to claim 6, wherein the processor is arranged, when interrupting the display of the content on the second display device, to freeze the display of the content on the second display device.

9. A system according to claim 6, wherein the processor is arranged, when interrupting the display of the content on the second display device, to reduce the frame rate of the display of the content on the second display device.

10. A system according to claim 6, wherein the processor is further arranged to detect a termination of an input of text on a user interface device associated with the first display device and resume the display of the content on the second display device.

11. A computer program product on a computer readable medium for mirroring the content of a first display device on a second display device, the product comprising instructions for:
displaying content on the first display device,
displaying the content on the second display device,
detecting the input of text on a user interface device associated with the first display device, and
interrupting the display of the content on the second display device.

12. A computer program product according to claim 11, wherein detecting the input of text on a user interface device associated with the first display device comprises detecting the use of a keypress helper for a password input.

13. A computer program product according to claim 11, wherein interrupting the display of the content on the second display device comprises freezing the display of the content on the second display device.

14. A computer program product according to claim 11, wherein interrupting the display of the content on the second display device comprises reducing the frame rate of the display of the content on the second display device.

15. A computer program product according to claim 11, and further comprising detecting a termination of an input of text on a user interface device associated with the first display device and resuming the display of the content on the second display device.
